(19) United States
(12) Patent Application Publication
(10) Pub. No.: US 2013/0099918 A1
(43) Pub. Date: Apr. 25, 2013

(54) METHOD, SYSTEM, AND APPARTUS FOR MONITORING AND TRANSMITTING PHYSIOLOGICAL CHARACTERISTICS

(71) Applicants: Bradley James DUNST, Oviedo, FL (US); Mark OOSTDYK, Cape Canaveral, FL (US)

(72) Inventors: Bradley James DUNST, Oviedo, FL (US); Mark OOSTDYK, Cape Canaveral, FL (US)

(21) Appl. No.: 13/276,544

(22) Filed: Oct. 19, 2011

(51) Int. Cl. G08B 1/08

(52) U.S. Cl. 340/539.12

(57) ABSTRACT

An apparatus, system, and method for monitoring a child's vitals and transmitting these vitals, through wireless technology, to a portable alert device. The child monitoring device may include a wearable device, a base station, and a portable alert device. The wearable device may record, among other things, a child's pulse oximetry, and send data regarding these readings, via short range transmission, to a base station which may analyze these readings, and transmit data regarding the child's health, via long range transmission, to the portable alert device. This apparatus will enable a caregiver to monitor a child for sign of health problems, including sleep apnea and SIDS, and alert the caregiver at the onset of any such problems.

### BACKGROUND

Parents are perpetually worried about their children, and this concern is paramount when a child is young or an infant. Many parents attempt to watch their infant or child as much as possible, but it is simply not possible to watch a child at every moment of the day. Parents have attempted to use advances in technology to watch their children, employing standard audio child monitors or even installing still and video cameras to watch their children remotely. However, these audio and visual solutions offer limited information about the child. There are many physiological events, including apnea, suffocation and Sudden Infant Death Syndrome (SIDS) that are hard to detect with mere visual and/or audio monitoring.

Newer technology has been introduced to child monitoring, allowing parents to monitor their child's blood oxygen saturation with a pulse oximeter, however, many of the current innovations have drawbacks or problems. Many of the current pulse oximetry methods only allow the monitor to be placed on a child's foot, or similar outer extremities which might allow the monitor to be dislodged or removed easily if the child thrashes or moves. Further, many of the current systems involving pulse oximetry limit the distance that this information can be transmitted and the manner in which the collected data is displayed to the parent.

### SUMMARY

According to at least one embodiment, an apparatus for monitoring the physiological characteristics of a human may be described. The apparatus can include a wearable device with at least one sensor for measuring vital signs, a microcontroller operably connected to the at least one sensor and a first transceiver that sends and receives data collected by the at least one sensor; a base station communicatively coupled to the wearable device with a second transceiver that sends and receives data, a microcontroller that determines the health of a human coupled to the wearable device, and a portable alert device with a third transceiver that sends and receives data to and from the base station and a display that shows data.

Another exemplary embodiment may include a system for monitoring the physiological characteristics of a child. The system can have a wearable device for monitoring physiological characteristics, a base station that receives transmissions from the wearable device and sends transmissions, and a portable alert device that receives transmissions from and sends transmissions to the base station.

Still another exemplary embodiment may include a method for monitoring and reporting physiological characteristics. The method can include steps for monitoring the vital signs of a human with a wearable pulse oximeter; transmitting data collected by the pulse oximeter through a microcontroller operably coupled to the pulse oximeter; receiving the data collected by the pulse oximeter at a base station that sends and receives transmissions through a second microcontroller, wherein the second microcontroller is included in the base station; transmitting the data collected from the base station to a portable device; and producing at least one of a visual and audio health status based on a transmission received from the base station at a portable alert device.

### BRIEF DESCRIPTION OF THE FIGURES

Advantages of embodiments of the current invention will be apparent from the following detailed description of the exemplary embodiments thereof, which description should be considered in conjunction with the accompanying drawings in which:

FIG. 1 is an exemplary flow chart depicting the logic employed by the wearable device;

FIG. 2 shows an exemplary view of a wearable device;

FIG. 3 is an exemplary flow chart depicting the logic employed by the base station;

FIG. 4 shows a front perspective view of an exemplary base station;

FIG. 5 shows a rear perspective view of an exemplary base station;

FIG. 6 is an exemplary flow chart depicting the logic employed by the portable alert device;

FIG. 7 shows a front perspective view of an exemplary portable alert device;

FIG. 8 shows a bottom perspective view of an exemplary portable alert device;

FIG. 9 shows a rear perspective view of an exemplary portable alert device.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

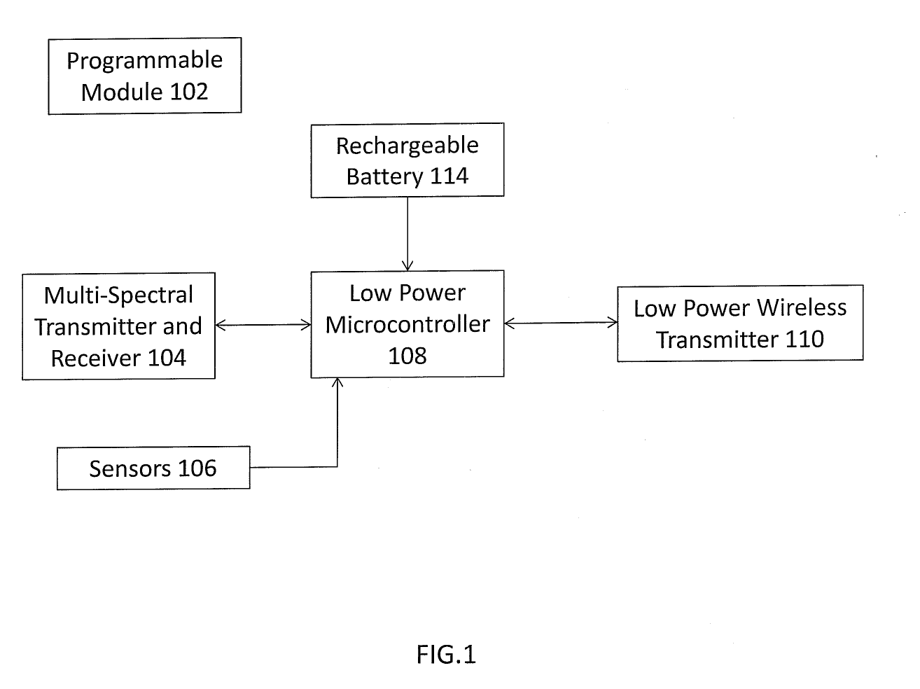

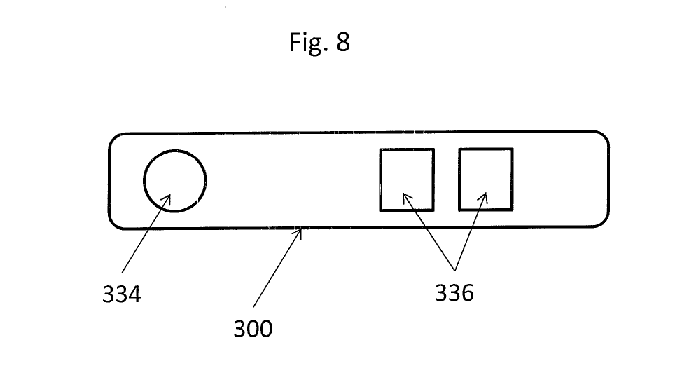

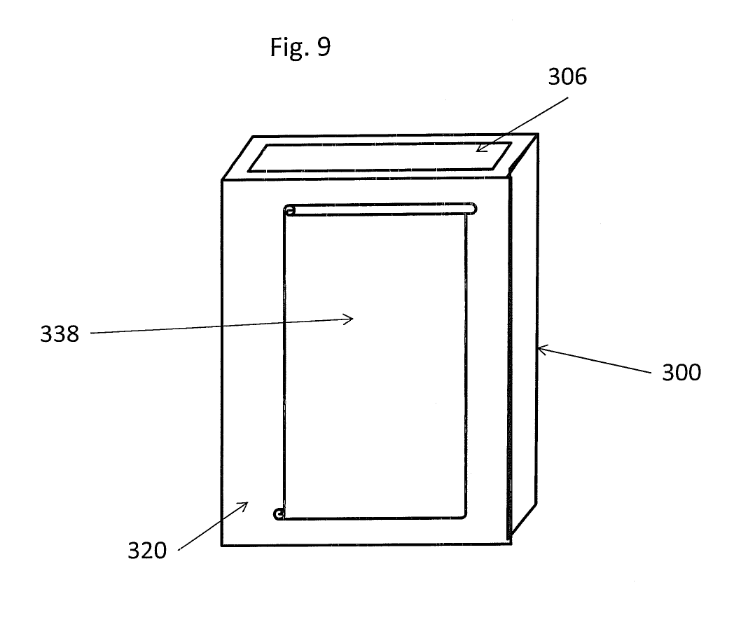

Generally referring to FIGS. 1-9, a monitoring device may be shown. Wearable device 100 can be worn by a human, such that it can facilitate the monitoring of the human's physiological characteristics. Wearable device 100 may communicate with base station 200, and as such, may transmit a human's physiological characteristics to base station 200. Base station 200, in turn, may transmit the physiological characteristics to portable device 300 allowing a caregiver to monitor the health or condition of the human.

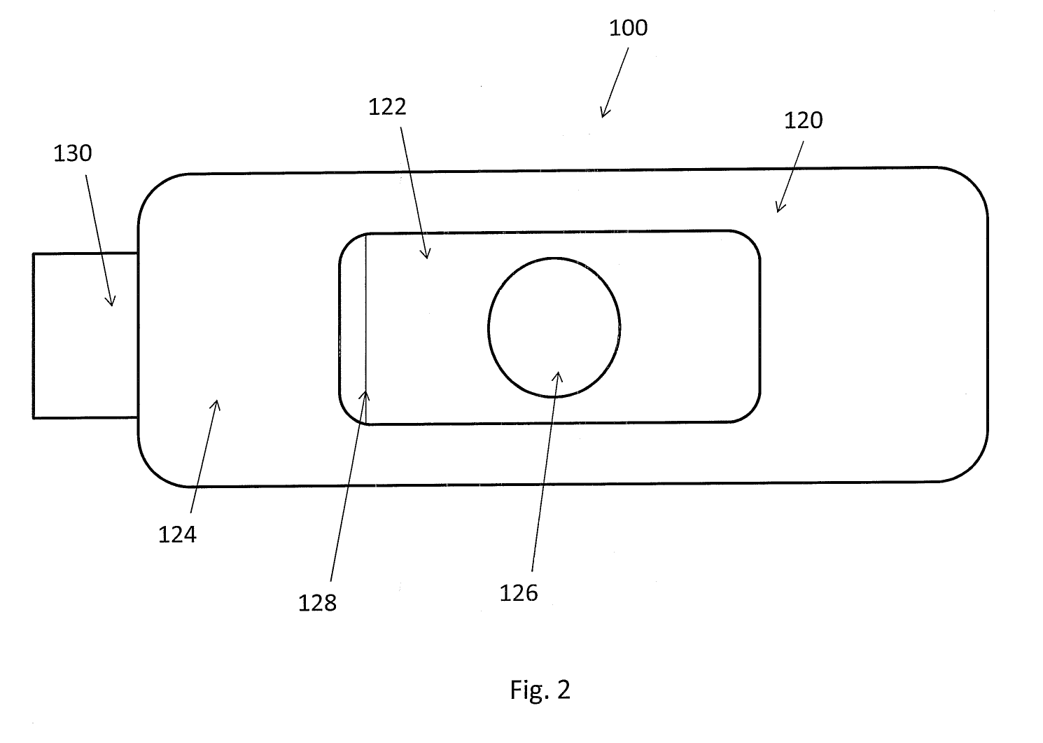

Referring to FIGS. 1 and 2, in one exemplary embodiment, wearable device 100 may include two parts: an outer shell 120 and programmable module 102. Outer shell 120 may be a soft band that may be capable of wrapping around and being secured to any part of human anatomy, such as a child's leg or arm, including, but not limited to, an upper arm or a thigh. It should be appreciated, however, that the exemplary embodiments described herein may be utilized with a human of any age or with any of a variety of veterinary applications, including uses with mammals to which the device may be coupled. Such an orientation or fitting of outer shell 120 may be useful to reduce motion artifacts and provide a desired location for accurately measuring physiological characteristics. Outer shell 120 may be any desired type of washable fabric, and, in one exemplary embodiment, may be held in place or secured by strap 130. Further, outer shell 120 may contain pocket 122, into which programmable module 102 may be inserted and secured. Pocket 122 may be located on interior side 124 of outer shell 120 and the interior side 124 can define the side of outer shell 120 that can be in contact with the child's skin. Pocket 122 may contain hole 126 and hole 126 can be located on interior side 124 and can allow programmable module 102 to be in direct contact with the child's skin.

Referring back to FIG. 1, in one exemplary embodiment, wearable device 100 may contain a low power microcontroller 108. Low power microcontroller 108 may receive transmissions from multi-spectral transmitter and receiver 104 and sensors 106. Further, low power microcontroller 108 may transmit data to multi-spectral transmitter and receiver 104, as well as to wireless transmitter 110, which may be a low power wireless transmitter. Low power wireless transmitter 110 may communicate with a similar transceiver included in base station 200, thus allowing wearable device 100 to transmit data regarding the physiological conditions of a child directly to base station 200.

Still referring to FIG. 1, in one exemplary embodiment, programmable module 102 may receive power from rechargeable battery 114. Rechargeable battery 106 may be charged by charging circuit 228, which may be located within base station 200. However, it is envisioned that rechargeable battery 114 may be charged using non-contact methodology. Non-contact methodology may include using any light frequency in combination with solar cells or photodiodes or utilizing eddy currents, electro-magnetic fields or other such mechanisms in order to recharge rechargeable battery 114.

Still referring to FIG. 1, in one exemplary embodiment, multi-spectral transmitter and receiver 104 may allow the microcontroller to determine the oxygen content of the blood by measuring transmittance, reflectance, or a combination thereof, through the child's skin. In an alternate exemplary embodiment, photoreceptors or pressures transducers could be used in order to determine the oxygen content of the child's blood. Multi-spectral transmitter and receiver 104 may include redundant transmitters and receivers in order to validate the measurements. Programmable module 102 may contain capabilities to determine whether programmable module 102 is in contact with the child's skin, such as detecting resistance or pressure across the child's skin.

Still referring to FIG. 1, in one exemplary embodiment, low power microcontroller 108 may receive data from sensors 106. Sensors 106 may be one or more of the following, in any combination: an accelerometer, wherein the accelerometer may detect the child's movements; a temperature sensor, wherein the temperature sensor may measure the child's body temperature; and one or more motion sensors, including vibrometers, piezoelectric sensors, gyrometers, gyroscopes, geomagnetic sensors, or any other motion detecting technologies. Sensors 106 may also be capable of detecting certain conditions relating to sleep apnea or SIDS. Alternatively, raw data may also be collected by any of sensors 106 and transmitted to base station 200 where the data may be processed and interpreted, as desired In one exemplary embodiment, wearable device 100 may include the ability to incorporate an ability to vibrate into wearable device 100, such that the wearable device could deliver a vibration to the child as a means to stimulate the child if an alarming condition is detected through sensors 106, multi-spectral transmitter and receiver 104, or a combination thereof. If the child moves, or the alarming condition dissipates, the stimulation may cease.

Still referring to FIG. 1, in one exemplary embodiment, low power wireless transmitter 110 may transmit pulse oximetry readings gathered by multi-spectral transmitter and receiver 104 using any desired wireless transmission technology, such as Zigbee or Bluetooth. In an alternate exemplary embodiment, low power wireless transmitter 104 may transmit any data gathered by sensor 106. However, it is envisioned that any wireless transmission technology, for example short range wireless transmission technology, may be utilized for this transmission so that the child is not subject to as much radio frequency as he or she would be if wearable device 100 utilized a high power transmission. Additionally, programmable module 102 may be programmed to only transmit data if the data shows a significant change from the previous transmission, wherein the significance may be determined by an algorithm or one of predetermined or automated inputs. Alternatively, programmable module 102 may transmit data at regular intervals if there is no significant change in the data, wherein the regular intervals may be predetermined inputs. These non-continuous transmissions may act to preserve battery life and reduce emissions of radio frequency, but it is also envisioned that wearable device may transmit data continuously.

Referring to FIG. 2, in one exemplary embodiment, wearable device 100 may contain a calibration feature that may allow the user to place wearable device 100 in a certain location, such as the upper arm, and set the system parameters to give a nominal reading for that area. This feature may contain limits, such that unreasonable values are reported to the caregiver as out of range before they are programmed into the device.

Still referring to FIG. 2, in one exemplary embodiment, strap 130 is envisioned as being a single, washable, adjustable strap. However, it is also envisioned that strap 130 may include multiple numbers of washable, adjustable straps. Strap 130 may also be child resistant and in one exemplary embodiment, may contain a feature which prevents over tightening, wherein the prevention of over tightening may be accomplished mechanically or electrically, and may serve to prevent circulation from being cut off in the particular limb where the device is being worn. In the exemplary embodiment displayed in FIG. 2, strap 130 may have a hook and loop fastener, such as Velcro®, such that strap 130 may hook and loop fasteners located on both ends of wearable device 100, as desired. However, it is envisioned that a multitude of removably attachable devices or adhesives could be used to secure the strap in place, including, but not limited to, a zipper, string and grommet, or any other attaching or securing apparatuses known in the art.

Still referring to FIG. 2, in one exemplary embodiment, pocket 122 may include hole 126 on the surface it shares with interior surface 124. Pocket 122 may allow programmable module 102 to make contact with the child's skin, such that data may be collected by sensors 106 and transmitted by multi-spectral transmitter and receiver 104. It is envisioned that wearable device will be able to determine if programmable module 102 is maintaining contact with the child's skin through hole 126. Further, it is envisioned that a contact electrode feature may allow for nervous system analysis to be performed through the contact point provided by hole 126. In the exemplary embodiment provided in FIG. 2, hole 126 may be centered on the interior surface of pocket 122, however, it is envisioned that hole 126 may be located at any position of the interior surface of pocket 122, such that hole 126 provides a contact point for programmable module 102 to make contact with the child's skin.

Still referring to FIG. 2, in one exemplary embodiment, pocket 122 may secure programmable module 102 within it by utilizing latch 128. Latch 128 may be located along any edge of pocket 122, such that it allows programmable module 102 to be inserted within pocket 122. In the exemplary embodiment displayed in FIG. 2, latch 128 may be located on the left edge of pocket 122, when viewed from an interior view. It can be appreciated, however, that in different exemplary embodiments different layouts and positioning may be used, as desired. Latch 128 may also be child resistant and in one exemplary embodiment, may have hook and loop fasteners, such that latch 120 may be a patch of hooks, wherein these hooks form interlocking bonds with a plurality of loops placed on a patch that is abutting latch 128, and said bonds act to close latch 128. However, it is envisioned that a multitude of removably attachable devices or adhesives could be used to secure latch 128, including, but not limited to, a zipper or a string and grommet, or any other attaching or securing apparatuses known in the art.

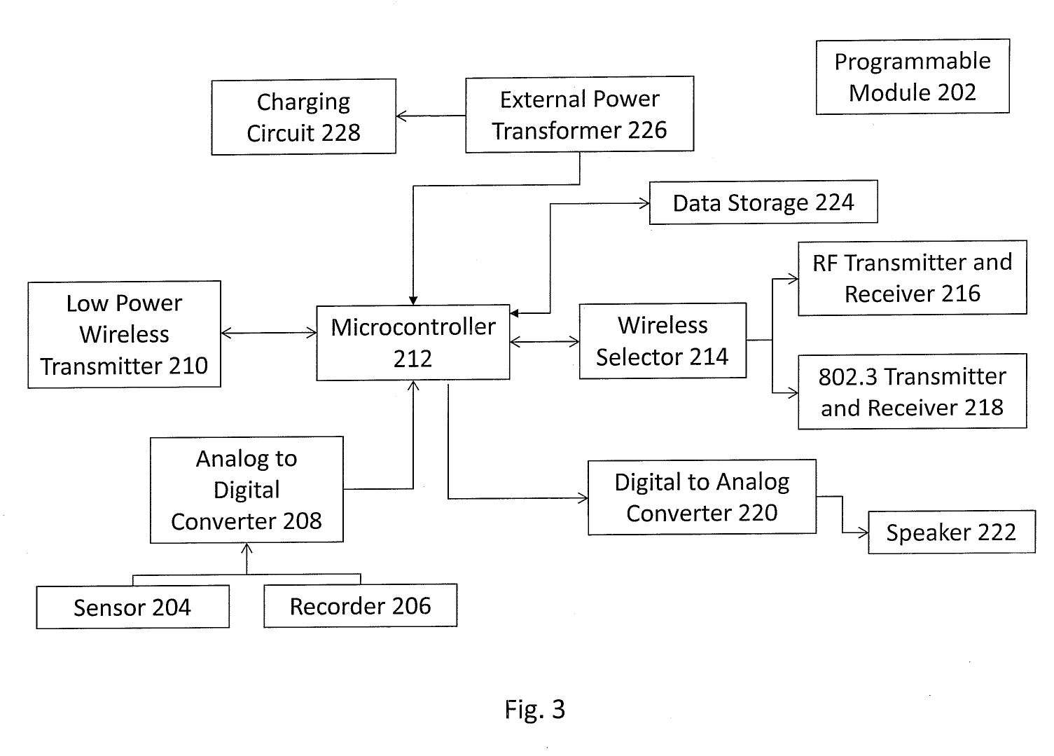

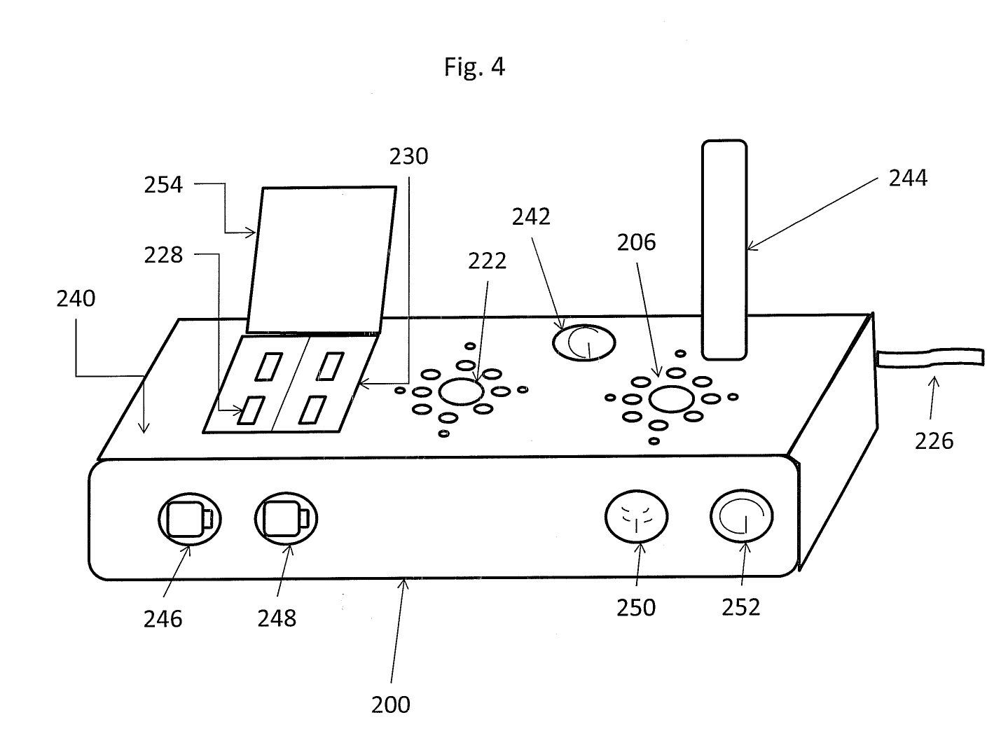

Referring to FIGS. 3 and 4, in one exemplary embodiment, base station 200 can have two parts: programmable module 202; and an enclosure 230 which houses programmable module 202. Base station 200, in certain embodiments, may have minimal extruding parts in order to maximize safety precautions, both for a child and for the functioning of the device. It is envisioned that base station 200 may be located in the same room, or in close range of, wearable device 100, such that base station 200 and wearable device 100 may exchange short range transmissions.

Referring to exemplary FIG. 3, programmable module 202 may contain a microcontroller 212, wherein microcontroller 212 may have health algorithms, receive transmissions from a plurality of data inputs, and send data transmissions via multiple methods, including the transmission of radio frequency, short wave technology and IEEE 802.3b/g/n transmissions. Microcontroller 212 may interpret data received in said transmissions in order to determine the health status of the child. In order to determine if an adverse condition exists, including, but not limited to sleep apnea and SIDS, microcontroller 212 may apply an algorithm combining threshold detection with timing and validation to the data collected by wearable device 100. The algorithms may also be trending to perform early detection of off-nominal conditions, which may help reduce false alarms and allow the caregiver to provide an earlier response to adverse conditions. Further, microcontroller 212 may communicate with wearable device 100 and portable alert device 300, allowing base station to receive and transmit data regarding the physiological conditions of the child.

Still referring to exemplary embodiments associated with FIG. 3, microcontroller 212 may receive data from low power wireless receiver 210 or analog to digital converter 208, as microcontroller 212 may be operably connected to both. Low power wireless transmitter 210 may receive transmissions from wearable device 100, via low power wireless transmitter 110, through the use of wireless transmission technology, such as Zigbee or Bluetooth, wherein such transmissions may relate to pulse oximetry readings gathered by wearable device 100. However, it is envisioned that any wireless transmission technology, for example any short range wireless transmission technology, may be utilized for transmissions between low power wireless transmitters 110 and 210, for example to minimize a child's exposure to high power transmissions. Once low power wireless transmitter 210 receives data in a transmission, this data may be sent to microcontroller 212.

Still referring to FIG. 3, analog to digital converter 208, may receive data from sensor 204 and recorder 206, such that analog to digital converter 208 may send data regarding the ambient conditions to microcontroller 212. It is envisioned that recorder 206 may able to capture audio or visual data, for example through the use of a microphone, a still camera and a video camera, or any combination thereof. Similarly, it is envisioned that sensor 204 may be able to detect a plurality of ambient conditions in the vicinity of the child, including, but not limited to, temperature, smoke, carbon monoxide, and any combination thereof.

Still referring to FIG. 3, in one exemplary embodiment, microcontroller 212 may send data to low power wireless transmitter 210, digital to analog converter 220, wireless selector 214, or data storage 224. Microcontroller 212 may send data to low power wireless receiver 210, which in turn may be sent directly to wearable device 100. Microcontroller 212 may, for example, send a transmission to wearable device 100 in order to trigger a vibration if sensors 106 detect that the child is in an adverse position. Next, microcontroller 212 may send data to analog converter 210, which may in turn be transmitted to speaker 222. Microcontroller 212 may, for example, send a transmission to speaker 222, by way of digital to analog converter 210, if the caregiver desires soothing sounds to be played for the child. Furthermore, microcontroller 212 may transmit data to wireless selector 214, which may in turn transmit data to either RF transmitter and receiver 216 or transmitter and receiver 218, which may be an IEEE 802.3b/g/n transmitter and receiver. RF transmitter and receiver 216 and transmitter and receiver 218 may each communicate with portable alert device 300, thus allowing base station to send data directly to portable alert device 300. Finally, microcontroller 212 may transmit data to data storage 224. Antenna 244 is located on base station 200 in order to enable these transmissions to be sent over longer ranges.

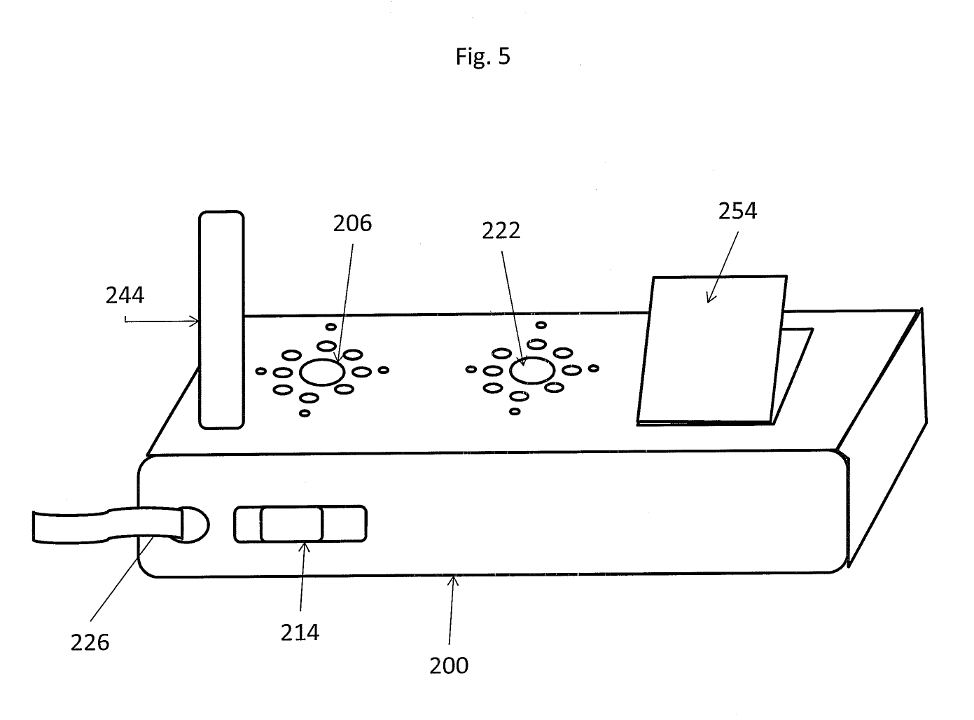

Referring to FIGS. 4 and 5 in one exemplary embodiment, enclosure 230 may be a rectangular box-like structure capable of housing programmable module 202. Enclosure 230 may be fabricated from plastic, metal, or any other material suitable to form a protective casing for programmable module 202, wherein “protective” is used to mean that base station 200 may be suitable for placement in a child's bedroom and may be suitable to allow programmable module 202 to function. In one exemplary embodiment, as depicted in exemplary FIG. 4, enclosure 230 may contain a plurality of indicators, buttons, switches, sensors, and other features located on its surfaces, including: wearable device charging indicator 246, portable alert device charging indicator 248, wireless indicator 250 and power indicator 252 located on the front surface of enclosure 230; speaker 222, recorder and/or microphone 206, power button 242, charging station 254, and antenna 244 located on the top surface of enclosure 230; and wireless selector 214 and external power transformer 226 located on the rear surface of enclosure 230. It is envisioned that other features, such as, but not limited to, a night light, may be included on the surface of enclosure 230. It is further envisioned that any of these indicators, buttons, switches, sensors, and features may be located on any surface of enclosure 230 that does hinder their purpose or function.

Referring to FIGS. 3 and 4, in a further exemplary embodiment, speaker 222 and recorder 206 may be located on the top surface of enclosure 230, however, it is envisioned that speaker 222 and recorder 206 may be located on any exterior surface of enclosure 230, provided they can sufficiently output and record data, respectively. It is envisioned that recorder 206 may utilize digital techniques for noise cancellation to prevent emitted sounds, such as those emitted by speaker 222, from being transmitted to portable alert device 300. It is also envisioned that speaker 222 and recorder 206 may enable base station 200 to contain a phone function, which may enable the caregiver to call for help, possibly hands-free. For example, if an emergency adverse condition were to arise, this feature may enable to call 911 while still assisting the child.

In still further exemplary embodiments, it should be appreciated that base station 200 may be a software tool or application implemented on a computer, portable computer, tablet computer, mobile phone and the like. In such examples, features of the device housing the software tool or application may be utilized in conjunction with the software tool or application to provide any or all of the functionality described herein. Such features include, but are not limited to, phone capabilities, data transmission and receiving capabilities, display capabilities and the like. Similarly, portable alert device 300, as described in more detail below, may also be any of a computer, portable computer, tablet computer, mobile phone and the like that is capable of utilizing a software tool or application.

Still referring to FIGS. 3 and 4, base station 200 may have charging circuits for wearable device 100 and portable alert device 300. In one exemplary embodiment, as depicted in FIG. 4, charging station 228, which may be capable of charging either device, separately or simultaneously, and may be located within charging area 254. Further, charging station 228 may receive power from external power converted from AC to DC by external power transformer 226. Wearable device charging indicator 246 may indicate if wearable device 100 is sufficiently connected to, and thus, being charged by, wearable device charging circuit 228, while portable alert device charging indicator 248 can similarly indicate if portable device 300 is sufficiently connected to, and thus, being charged by, portable alert device charging circuit 228. It is not necessary that wearable device 100 and portable alert device 300 be charged by contact, as it is envisioned that they may be charged by non-contact methodology, including, but not limited to, using any light frequency in combination with solar cells or photodiodes, utilizing eddy currents, or using electro-magnetic fields to charge the devices.

Still referring to FIGS. 3 and 4, converted AC power may also supply power to programmable module 202, as well as, base station 200 as a whole. However, it is envisioned, in an alternate exemplary embodiment, that power may be supplied to charging circuit 228, as well as to programmable module 202 and base station 200 as a whole, by battery, or any other wireless power technology, such as non-contact means including solar cells and photodiodes, such that base station 200 may be portable. Base station power indicator 252 may be able to indicate whether base station 200 is currently charging, charged, sufficiently supplied with power or any other indication relating to powering base station 200.

Referring now to FIGS. 3-5, in one exemplary embodiment, base station 200 may transmit signals to portable alert device 300 via either RF transmitter and receiver 216 or transmitter and receiver 218 and, in some exemplary embodiments, these signals may be encrypted in any known or desired manner. As demonstrated in the rear perspective view provided in exemplary FIG. 5, a caregiver may determine how base station 200 may communicate with portable alert device 300, either by RF transmission via transmitter and receiver 216 or by wireless packet transmission, such as IEEE 802.3b/g/n wireless packet transmission, via transmitter and receiver 218. In one exemplary embodiment, as demonstrated by FIG. 5, wireless selector 214 may be located on the rear surface of enclosure 230, however, it is envisioned that wireless selector 214 may be located on any exterior surface of enclosure 230, provided it may still enable the caregiver to determine the method by which data is transmitted to portable alert device 300. Wireless indicator 250 may indicate whether base station 200 is capable of, or is currently, transmitting wireless signals.

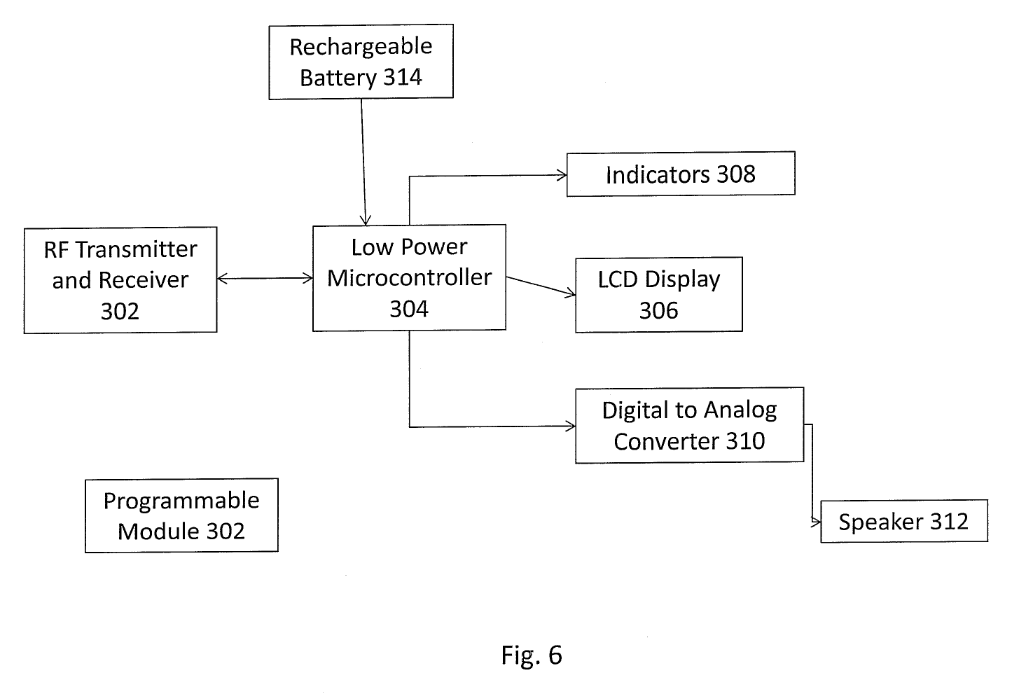

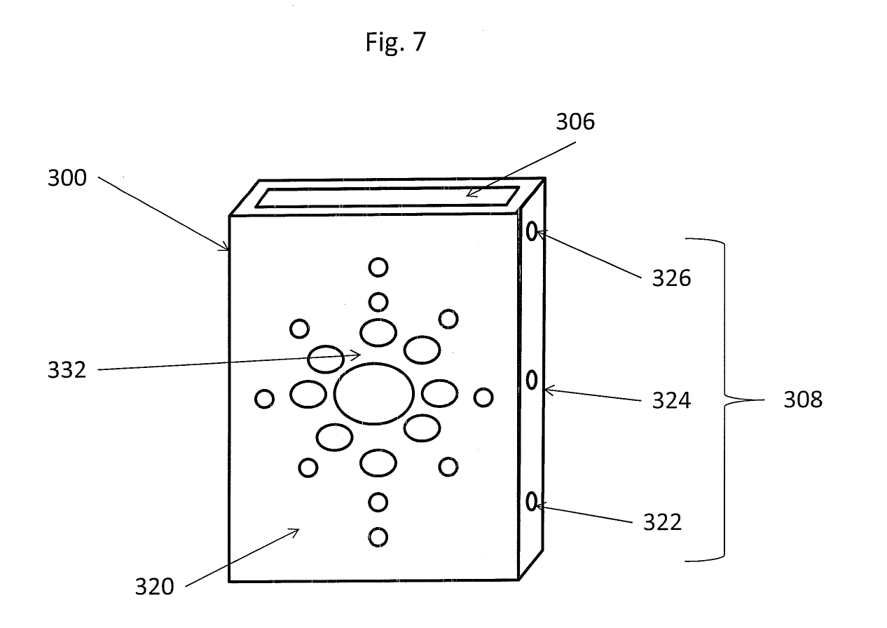

Referring now to exemplary FIGS. 6 and 7, portable alert device 300 can include at least two parts: programmable module 302 and an enclosure which can house programmable module 302. Portable alert device 300 may be able to communicate directly with base station 200, in order to receive health updates that base station 200 has determined based on the data base station 200 receives from wearable device 100. Portable alert device has the ability to provide audio and visual alerts to the caregiver if the child is experiencing an adverse health condition.

In exemplary FIG. 6, programmable module 302 may include low power microcontroller 304, wherein low power microcontroller 304 may send and receive transmissions to and from RF transmitter and receiver 304, respectively. Microcontroller 304 may also send data to analog to digital converter 310, Display 306 or Indicators 308. If wireless selector 214 is in the RF transmission position, portable alert device 300 may receive transmissions from base station 200 via RF transmitter and receiver 302.

Still referring to exemplary FIG. 6, if wireless selector 214 is in the “802.3” position, it is still envisioned that portable device 300 may be capable of receiving transmissions from base station 200. In one exemplary embodiment, portable alert device 300 may be capable of utilizing a software solution for standard consumer electronics, such as computers, tablets, or cellular telephones, wherein the consumer electronic device may receive, or be programmed to receive IEEE 802.3b/g/n transmissions. In an alternate exemplary embodiment, portable alert device may contain a wireless selector and an IEEE 802.3b/g/n transmitter and receiver in addition to RF transmitter and receiver 304. The IEEE 802.3b/g/n transmitter and receiver and wireless selector could be configured in portable alert device 300 to be operably connected to each other and low power microcontroller 302 in the same, or a similar, manner that wireless selector 214, RF transmitter and receiver 216 and IEEE 802.3b/g/n transmitter and receiver 218 are operably connected to each other and microcontroller 212.

Still referring to exemplary FIG. 6, it is envisioned that the caregiver may be able to send instructions or commands to wearable device 100, through base station 200, whether via RF transmission or via IEEE 802.3b/g/n wireless packets, which could, for example, instruct wearable device 100 to vibrate when the child is in an adverse position in order to coax the child to move. Additionally, low power microcontroller 304 may send data to analog converter 310, which may in turn be transmitted to speaker 312. Low power microcontroller 304 may, for example, send a transmission to speaker 312, by way of digital to analog converter 310, if the portable alert device receives data from base station 200 indicating that the child, at that moment, has adverse physiological characteristics, including, but not limited to, the onset of sleep apnea or SIDS. It is envisioned that low power microcontroller 304 may be able to transmit audio signals originally captured by sensors 106 and transmitted through base station 200 to portable alert device 300, to speaker 312, through digital to analog converter 310, such that the caregiver may be able to listen to the child. Portable alert device 300 may also alert that caregiver of adverse physiological conditions via display 306 and indicators 308. Low power microcontroller 304 may be configured to generate images on display 306, wherein these images can include, for example, data and numbers that represent numerical measurements. Additionally, in some further exemplary embodiments, a camera, such as a video camera, may be utilized with any of the systems or methods described herein and video data may be transmitted and display on display 306. Similarly, low power microcontroller 304 may be configured to operate color-coded light-emitting diodes, wherein the color emitted may represent a certain health-related measurement, where green could signify normal measurements, and red could signal an emergency.

Referring now to exemplary FIGS. 7-9, portable alert device 300 may include enclosure 320 which may be a small rectangular enclosure, similar in size to a cellular telephone or beeper. However, it is envisioned that enclosure 320 may take any shape or size capable of housing programmable module 302. Enclosure 320 may contain speaker 312 on its front surface; child health indicator 326, wireless indicator 324 and battery indicator 322 on its right side surface; display 306 on its top surface; power input 334 and charging contacts 336 on its bottom surface; and clip 338 on its rear surface, although any desired orientation or positioning of these components may be utilized. However, as with other exemplary embodiments, clip 338 need not be a clip, but may be a device capable of allowing the caregiver to carry portable device 300 on his person. It is envisioned that other features, such as, but not limited to a night light, may be included on the surface of enclosure 320. It is further envisioned that any of the aforementioned features may be located on any surface of enclosure 320 that does not hinder their purpose or function.

Referring to exemplary FIGS. 6-8, in one exemplary embodiment, portable alert device 300 may be capable of being charged via either external power or charging circuit 228 of base station 200. In one exemplary embodiment, charging contacts 336 would simply need to be placed in contact with charging circuit 228 in order to charge rechargeable battery 314. In an alternate exemplary embodiment, rechargeable battery 314 may be charged by external power which may be introduced to the battery via power input 334. Rechargeable battery 314 may provide programmable module 302 with sufficient power to operate. It is also envisioned that rechargeable battery 314 may be charged using non-contact methodology. Non-contact methodology can include using any light frequency in combination with solar cells or photodiodes or utilizing eddy currents, electro-magnetic fields or other such mechanisms in order to recharge rechargeable battery 114.

Referring now to FIGS. 6-9, in one exemplary embodiment, portable alert device 300 may include the ability to use an audio or visual cue, for example a proprietary, pleasant, rhythmic indication, to the caregiver to help them become aware when abnormal conditions occur. In one exemplary embodiment, this indication could be a by-the-minute beep that sounds when: the batteries on wearable device 100, base station 200 and portable alert device 300 are charged and functioning properly; transmissions between wearable device 100, base station 200 and portable alert device 300 are functioning properly; and all of the detected vitals are determined to be adequate or appropriate. However, it is envisioned that the indication could be given based on any combination of parameters relating to the invention. If one of the parameters failed to be satisfied, for example, if the aforementioned exemplary transmissions between base station 200 and wearable device 100 were no longer capable of being sent, the indication, which in this exemplary embodiment may be a beep, would stop.

Referring generally to exemplary FIGS. 1-9, the baby monitoring device may be capable of sleep/waketime monitoring. Wearable device 100 may be capable of monitoring motion, heartbeat, temperature, sound levels, and other metrics, which base station 200 may use to determine how long the child is awake or sleeping. Base station 200 could be programmed, via programmable module 202, to transmit such sleep/waketime monitoring to portable alert device 300, such that it is provided to a caregiver. A caregiver may be able to download sleep session data from portable device 300 if he or she so desires.

In one exemplary embodiment, wearable device, which may include programmable module 102 inserted into pocket 122 of exterior shell 120, may be secured to a baby's upper arm. In this exemplary configuration, module 102 may be in contact with the baby's skin through hole 126, and thus, may collect pulse oximetry readings from the baby. Once these readings have been taken, wearable device 100 may transmit these readings, via programmable module 102, to base station 200, wherein the transmissions may be sent through short range wireless technology. After receiving pulse oximetry transmissions, base station 200, via programmable module 202, may apply health algorithms to the data in order to determine the baby's vitals. Any information regarding the baby's vitals may, in turn, be transmitted to portable alert device 300, in order to allow a caregiver to monitor their child's well-being. Portable alert device 300 may display the vitals as numbers, such as temperature, blood pressure, or hear rate on display 306, as colors, wherein green may indicate healthy, yellow may indicate abnormal, and red may indicate an emergency, or any combination thereof.

When used in this configuration, a parent might be able to, among other things, quickly walk the dog outside while the baby is sleeping while continuing to monitor the baby's well-being. Wearable device 100 may be safely secured to the baby's arm, leg or any other desired location in order to ensure continued monitoring of the baby's health, which may allow a caregiver to simply glance at portable device 300 in order to stay apprised of the baby's vitals. Further, portable alert device 300 may be continuously updated by base station 200, and may provide a visual or audio alert if an adverse condition, such as sleep apnea or sudden infant death syndrome, comes to exist.

Still referring generally to exemplary FIGS. 1-9, wearable device 100 may further include location capabilities. For example, wearable device 100 can utilize a local positioning system that allows the location of wearable device 100, as well as the wearer of device 100, to be located within a wifi zone, for example. Boundaries may be set that allow for alerts to be transmitted from wearable device 100 to base station 200 and portable alert device 300 when wearable device 100 approaches a predetermined or predefined boundary, or where a wifi signal begins to weaken. Additionally, in some further exemplary embodiments, wearable device 100 may also have global positioning capabilities. For example, if wearable device is outside of the range of a wifi signal, it may utilize a global positioning system (GPS) transceiver to acquire and transmit location data. This data can be sent via any desired communication methodology to base station 200 or portable alert device 300, as desired. Thus, in such exemplary embodiments, a wearer of wearable device 100 may also provide location information about the wearer so that other parties with access to base station 200 or portable alert device 300 may track the wearer of wearable device 100, substantially regardless of location.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. An apparatus for monitoring the physiological characteristics of a human, comprising:
a wearable device with at least one sensor for measuring vital signs, a microcontroller operably connected to the at least one sensor and a first transceiver that sends and receives data collected by the at least one sensor;
a base station communicatively coupled to the wearable device with a second transceiver that sends and receives data, a microcontroller that determines the health of a human coupled to the wearable device, and
a portable alert device with a third transceiver that sends and receives data to
and from the base station and a display that shows data.

2. The apparatus according to claim 1, wherein the wearable device has a soft outer shell.

3. The apparatus according to claim 2, further comprising a soft outer shell with an exterior pocket capable of housing an electronic circuit.

4. The apparatus according to claim 3, the soft outer shell further comprising an interior hole that facilitates the apparatus contacting the skin of the human.

5. The apparatus according to claim 1, further comprising an electronic circuit including that determines whether the apparatus is in contact with the child's skin.

6. The apparatus according to claim 1, further comprising a base station that converts received AC power into DC power

7. The apparatus according to claim 1, further comprising a base station that measures ambient environmental conditions.

8. The apparatus according to claim 1, wherein the third transceiver in the portable alert device is a radio frequency transceiver.

9. The apparatus according to claim 1, wherein the third transceiver in the portable alert device is a IEEE 802.3b/g/n wireless transceiver.

10. The apparatus according to claim 1, wherein the at least one sensor is a pulse oximeter.

11. The apparatus according to claim 1, wherein the base station is one of a computer, tablet computer and mobile phone.

12. The apparatus according to claim 1, wherein the portable alert device is one of a computer, tablet computer and mobile phone.

13. The apparatus according to claim 1, wherein the wearable device further comprises local position and global position capabilities.

14. A system for monitoring the physiological characteristics of a child comprising:
a wearable device for monitoring physiological characteristics, comprising:
a pulse oximeter and an electronic circuit for measuring vital signs;
a microcontroller operably coupled to the pulse oximeter, and transmits data collected by said pulse oximeter;
a base station that receives transmissions from the wearable device and sends transmissions, wherein said base station comprises:
a microcontroller that determines the health of a human from data received from said wearable device;
at least one wireless transmitter that sends and receives transmissions from said wearable device and to a portable device;
a portable alert device that receives transmissions from and sends transmissions to the base station, wherein said portable alert device comprises:
an electronic circuit;
a transceiver that receives the health status from said base station;
a display;
a microcontroller in the electronic circuit operably coupled to both the display and the radio frequency transceiver to send signals based on the data received from said wearable device, as transmitted through said base station, to the display data relevant to the health of the child.

15. The system of claim 14, further comprising a portable alert device that receives transmissions

16. The system of claim 15, wherein the portable alert device further comprises an IEEE 802.3b/g/n wireless transceiver.

17. The system of claim 15, wherein the portable alert device further comprises a radio frequency transceiver.

18. A method for monitoring and reporting physiological characteristics, comprising:
monitoring the vital signs of a human with a wearable pulse oximeter;
transmitting data collected by the pulse oximeter through a microcontroller operably coupled to the pulse oximeter;
receiving the data collected by the pulse oximeter at a base station that sends and receives transmissions through a second microcontroller, wherein the second microcontroller is included in the base station;
transmitting the data collected from the base station to a portable device; and
producing at least one of a visual and audio health status based on a transmission received from the base station at a portable alert device.

19. The method of claim 18, wherein transmissions between the base station and the portable device are be sent by at least one of radio frequency or IEEE 802.3b/g/n wireless packets.

20. The method of claim 18, wherein transmissions between the wearable device and the base station are be sent by short range communication.

21. The method of claim 18, wherein the portable device comprises a digital display screen.
